(19) United States
(12) Patent Application Publication
(10) Pub. No.: US 2007/0179915 A1
(43) Pub. Date: Aug. 2, 2007

(54) System and method of remote videoing of meter readings

(76) Inventor: Shen-Hung Hsu, Lujhu Township (TW)

Correspondence Address: RABIN & BERDO, P.C.;Suite 500, 1101 14 Street, N.W., Washington, DC, 20005, US

(21) Appl. No.: 11/345,375

(22) Filed: Feb. 2, 2006

(51) Int. Cl. G06F 17/00

(52) U.S. Cl. 705/412

(57) ABSTRACT

This invention is a type of system and method of remote videoing of meter readings. It can be used for remotely recording the readings of a meter. It comprises a video module that videos the figures indicated on the meter into meter data, a communication module at the household end that receives data and sends the meter data videoed by the video module through a communication medium at the household end, and a remote data processing system that sends and controls commands as well as receives the meter data sent by the communication module at the household end and calculates the meter accordingly. This invention uses the video module to video the figures indicated on the meter into meter data and then sends the meter data to the remote data processing system through the communication module at the household end with no change to traditional meter facilities. The costs of manual meter reading can be saved and efficiency can be increased.

### BACKGROUND OF THE INVENTION

I. Field of the Invention

This invention is a type of system and method of remotely videoing meter readings. Specifically, it refers to a type of system and method of meter recording that uses video to record the figures on the meter and then sends it to the remote data processing system for processing and calculation.

II. Description of the Prior Art

Traditional meter reading method uses manual method to read and record meter such as public electricity meter, public water meter, gas meter, etc. at each household. The meter reader has to read and record the meter at every household. Travelling time is increased if the household is located in far-flung areas. Not only is this method inefficient, but depending on the meter reader to read and record the meter will also easily result in problems in data processing later due to data error.

As a result, a type of remote meter reading product that improves the traditional method can be seen on the market currently. It combines the meter with the communication module at the household end to form an entirely new product. The meter data is sent for remote processing by the communication module at the household end. Labour and cost can be reduced. However, construction of this type of product is more difficult, as installing this product requires dismantling every group of original meter. Moreover, the accommodations in most parts of cities nowadays are all apartments. Their meters are all concentrated in a certain area of the building. If the size of this type of product is too big to be installed at the original location, all the meters have to be dismantled and pipelines have to be reinstalled in order to install this product, increasing the difficulties and costs of construction by a great extent. Furthermore, when using it with the meters in other systems, such as the various inspection and testing facilities in factories, this product has to be redesigned to meet requirements. The inspection and testing facilities even have to be redesigned or purchased, increasing costs by a great extent.

For example, patent bulletin number 580643—remote wireless meter reading method and system, the product has to be redesigned for every type of meter and measuring system and the system has to be completely dismantled and reinstalled. A new set of measuring system even has to be repurchased. The money invested in this system could far exceed the reduction in costs and is not economically effective and beneficial.

In view of the foregoing, this invention provides “a type of remote video meter reading system and method”. Not only can labour costs be saved, but this invention can be installed freely under the condition of no change to the original configuration of the meter measuring system. This invention reduces the difficulties of installation and achieves the benefits and convenience brought about by remote meter reading.

### SUMMARY OF THE INVENTION

The main objective of this invention is to provide a type of remote video meter reading system and method, using videoing method to record the figures on the meter, and then sending the recorded figures to the remote data processing system for processing and calculation. Not only can labour and costs be saved, but this invention can be freely installed under the condition of no change to the original configuration of the meter, reducing the difficulties of installation.

Another objective of this invention is to provide a type of remote video meter reading system and method comprising a video module. The video module videos the figures indicated on the meter into meter data.

Another objective of this invention is to provide a type of remote video meter reading system and method comprising a communication module at the household end. The communication module at the household end receives data and sends the meter data videoed by the video module through a communication medium at the household end.

Another objective of this invention is to provide a type of remote video meter reading system and method comprising a remote data processing system. The remote data processing system receives the meter data sent by the communication module at the household end and calculates the meter accordingly.

Another objective of this invention is to provide a type of remote video meter reading system and method, wherein the video module can comprise an image acquisition component using either optical CCD component or CMOS component.

Another objective of this invention is to provide a type of remote video meter reading system and method, wherein the meter data videoed by the video module could be digital image data.

Another objective of this invention is to provide a type of remote video meter reading system and method, wherein the communication medium of the communication module at the household end could be either wire communication technology or wireless communication technology.

Another objective of this invention is to provide a type of remote video meter reading system and method, wherein the remote data processing system could further comprise a communication module at the data processing end and send and receive data through a communication medium at the data processing end.

Another objective of this invention is to provide a type of remote video meter reading system and method, wherein the communication medium of the communication module at the data processing end could be either wire communication technology or wireless communication technology.

Another objective of this invention is to provide a type of remote video meter reading system and method, wherein the remote data processing system could comprise an identification system. The identification system identifies the figures of the meter data, converts them into digital numeric data, and calculates the meter accordingly.

Another objective of this invention is to provide a type of remote video meter reading system and method that could further comprise a memory at the household end to store data and meter data.

Another objective of this invention is to provide a type of remote video meter reading system and method that could further comprise a microprocessor at the household end. The microprocessor at the household end controls the activities of the video module and the communication module at the household end, and stores and retrieves the data of the memory.

Another objective of this invention is to provide a type of remote video meter reading system and method that could further comprise a data relay station. Data communication between the communication module at the household end and the communication module at the data processing end can be transferred through the data relay station.

To achieve the foregoing objectives, this invention provides a type of remote video meter reading system that could be used for remotely recording meter, comprising:

A video module that videos the figures indicated on the meter into meter data;

A communication module at the household end that receives data and sends the meter data videoed by the video module through the communication medium at the household end;

A memory at the household end that stores data and meter data;

A microprocessor at the household end that controls the activities of the video module and the communication module at the household end, as well as stores and retrieves the data of the memory at the household end; and

A remote data processing system that receives the meter data sent by the communication module at the household end and calculates the meter according, comprising

A communication module at the data processing end that sends and receives data through the communication medium at the data processing end; and

A identification system that identifies the figures of the meter data and converts them into digital numerical data.

Therefore, to achieve the foregoing objectives, this invention provides a type of remote video meter reading method, comprising the below steps:
(1) The video module accepts the control of the microprocessor at the household end and videos the figures indicated on the meter into digital data;
(2) The microprocessor at the household end saves the meter data in the memory at the household end;
(3) The microprocessor at the household end controls the communication module at the household end to send the meter data videoed by the video module to the remote data processing system through the communication medium at the household end;
(4) The remote data processing system receives the meter data through the communication medium at the data processing end contained inside the communication module at the data processing end;
(5) The remote data processing system uses an identification system to identify the figures of the meter data and convert them into digital numeric data.

This filing will be better understood from the drawings and detailed description below.

### BRIEF DESCRIPTION OF THE DRAWINGS

FIG. 1 is the diagram of the remote video meter reading system.

FIG. 2 is the process flow chart of the remote video meter reading method.

### DESCRIPTION OF THE PREFERRED EMBODIMENT

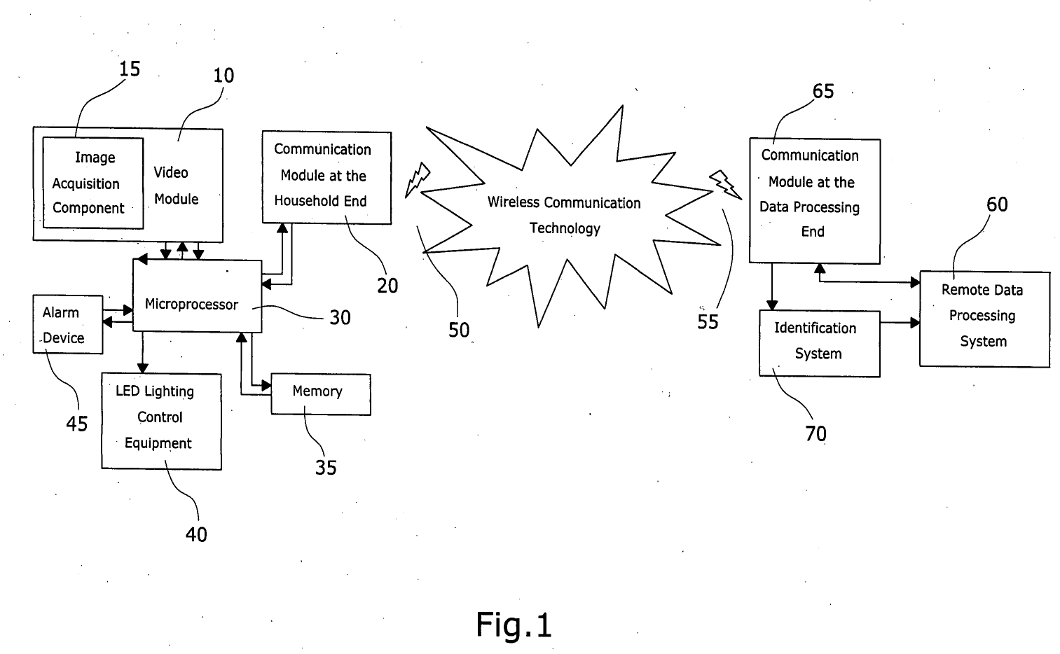

Referring to FIG. 1, this invention, a type of remote video meter reading system, can be used for remotely recording the readings of a meter. The video module 10 videos the figures indicated on the meter into digital data. The communication module at the household end 20 receives data and sends the meter data videoed by the video module 10 through the communication medium at the household end 50. The memory at the household end 35 saves data and meter data. The microprocessor at the household end 30 controls the activities of the video module 10 and the communication module at the household end 20, and stores and retrieves the data of the memory at the household end 35. The remote data processing system 60 receives meter data sent by the communication module at the household end 20 and calculates the meter accordingly, comprising a communication module at the data processing end 65 that sends and receives data through a communication medium at the data processing end 55. The identification system 70 identifies the figures of the meter data and converts them into digital numerical data.

A noteworthy point is that the meter data videoed by the video module 10 described above could be digital image data. Furthermore, the video module 10 could comprise an image acquisition component 15 using either optical CCD component or CMOS component to video the figures indicated on the meter. Other technologies that can be used for the image acquisition component 15 also lie within the scope of the claims.

A noteworthy point is that the communication medium at the household end 50 of the communication module at the household end 20 described above, as well as the communication medium at the data processing end 55 of the communication module at the data processing end 65, could be either wire communication technology or wireless communication technology. In this example, both the two ends use wireless communication technology to transfer data. The wireless communication technology could be GSM, 3G, WLAN, WiMAX, etc. Wire communication technology such as ethernet, RS485, etc. signal wire could also be used to achieve the objective of long distance data transfer.

A noteworthy point is that if the distance between the communication module at the household end 20 and the communication module at the data processing end 65 is too long leading to a reduction in signal strength, the data relay station could be used to increase signal strength. When the two ends use different communication technologies to send or receive data, the data relay station could also be used as the conversion interface.

A noteworthy point is that when lighting is insufficient, the microprocessor at the household end 30 can control the LED lighting control equipment 40 to provide brightness so that the video module 10 can video clear images.

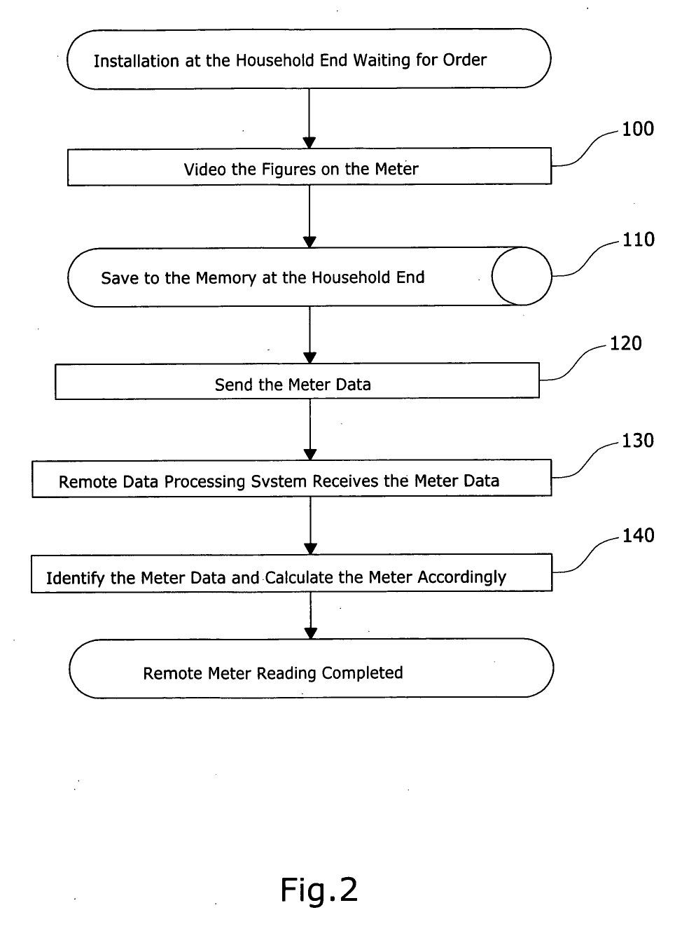

Please refer to FIG. 2, and at the same time refer to FIG. 1, the method by which this invention achieves remote video meter reading comprises the following steps:

Step (1)100, the video module 10 accepts the control of the microprocessor at the household end 30 and videos the figures indicated on the meter into meter data;

Step (2)110, the microprocessor at the household end 30 saves the meter data in the memory at the household end 35;

Step (3)120, the microprocessor at the household end 30 controls the communication module at the household end 20 to send the meter data videoed by the video module 10 to the remote data processing system 60 through the communication medium at the household end 50;

Step (4)130, the remote data processing system 60 receives the meter data through the communication medium at the data processing end 55 contained inside the communication module at the data processing end 65;

Step (5)140, the remote data processing system 60 uses an identification system 70 to identify the figures of the meter data and convert them into digital numerical data.

Various modifications of this invention can be made by those skilled in the art without departing from the scope of the appended claims.

What is claimed is:

1. A type of remote video meter reading system that can be used for remotely recording the readings of a meter, comprising:
A video module that videos the figures indicated on the meter into digital data;
A communication module at the household end that receives data and sends the meter data videoed by the video module through the communication medium at the household end;
A memory at the household end that saves data and meter data;
A microprocessor at the household end that controls the activities of the video module and the communication module at the household end, as well as stores and retrieves the data of the memory at the household end; and
A remote data processing system that receives the meter data sent by the communication module at the household end and calculates the meter accordingly, comprising
A communication module at the data processing end that sends and receives data through the communication medium at the data processing end; and
A identification system that identifies the figures of the meter data and converts them into digital numeric data.

2. The remote video meter reading system of claim 1, wherein the video module can comprise an image acquisition component using either optical CCD component or CMOS component.

3. The remote video meter reading system of claim 1, wherein the video module can comprise an image compression unit that can compress and reduce the data size of the meter data.

4. The remote video meter reading system of claim 1, wherein the communication media of both the communication module at the household end and the communication module at the data processing end could be either wire communication technology or wireless communication technology.

5. The remote video meter reading system of claim 1, wherein the communication module at the household end and the communication module at the data processing end can transfer data communication to the other end through a data relay station.

6. The method of a type of remote video meter reading comprises the following steps:
(1) the video module accepts the control of the microprocessor at the household end to video the figures indicated on the meter into meter data;
(2) the microprocessor at the household end saves the meter data in the memory at the household end;
(3) The microprocessor at the household end controls the communication module at the household end to send the meter data videoed by the video module to the remote data processing system through the communication medium at the household end;
(4) The remote data processing system receives the meter data through the communication medium at the data processing end contained inside the communication module at the data processing end;
(5) The remote data processing system uses an identification system to identify the figures of the meter data and convert them into digital numerical data.

7. The remote video meter reading method of claim 6, wherein the video module can comprise an image acquisition component using either optical CCD component or CMOS component.

8. The remote video meter reading method of claim 6, wherein the video module can comprise an image compression unit to compress and reduce the data size of the meter data.

9. The remote video meter reading method of claim 6, wherein the communication media of both the communication module at the household end and the communication module at the data processing end could be either wire communication technology or wireless communication technology.

10. The remote video meter reading method of claim 6, wherein the communication module at the household end and the communication module at the data processing end can transfer data communication to the other end through a data relay station.

11. The type of remote video meter reading system that can be used for remotely recording the readings of a meter comprises:
A video module that videos the figures indicated on the meter into meter data;
A communication module at the household end that receives data and sends the meter data videoed by the video module through the communication medium at the household end; and
A remote data processing system that receives the meter data sent by the communication module at the household end and calculates the meter accordingly, comprising
A communication module at the data processing end that sends and receives data through the communication medium at the data processing end; and
A identification system that identifies the figures of the meter data and converts them into digital numerical data.

12. The remote video meter reading system of claim 11, wherein the video module can comprise an image acquisition component using either optical CCD component or CMOS component.

13. The remote video meter reading system of claim 11, wherein the video module can comprise an image compression unit to compress and reduce the data size of the meter data.

14. The remote video meter reading system of claim 11, wherein the communication media of both the communication module at the household end and the communication module at the data processing end could be either wire communication technology or wireless communication technology.

15. The remote video meter reading system of claim 11, wherein the activities of the video module and the communication module at the household end can be controlled by either the remote data processing system or the timer management device.

16. The method of the type of remote video meter reading comprises the following steps:
(1) the video module accepts the control of the control signal to video the figures indicated on the meter into meter data;
(2) next, the communication module at the household end sends the meter data videoed by the video module to the remote data processing system through the communication medium at the household end;
(3) the remote data processing system receives the meter data through the communication medium at the data processing end contained in the communication module at the data processing end;
(4) the remote data processing system uses an identification system to identify the figures of the meter data and convert them into digital numeric data.

17. The remote video meter reading method of claim 16, wherein the video module can comprise an image acquisition component using either optical CCD component or CMOS component.

18. The remote video meter reading method of claim 16, wherein the video module can comprise an image compression unit to compress and reduce the data size of the meter data.

19. The remote video meter reading method of claim 16, wherein the communication media of both the communication module at the household end and the communication module at the data processing end could be either wire communication technology or wireless communication technology.

20. The remote video meter reading system of claim 16, wherein the control signal could be sent by either the remote data processing system or the timer management device.
